(19) United States
(12) Patent Application Publication
(10) Pub. No.: US 2008/0094070 A1
(43) Pub. Date: Apr. 24, 2008

(54) Linear analog sensor for in line measurement of the conductivity of beer and similar liquids

(75) Inventor: David J. Dlugos, Beacon Falls, CT (US)

Correspondence Address: ST. ONGE STEWARD JOHNSTON & REENS, LLC, 986 BEDFORD STREET, STAMFORD, CT, 06905-5619, US

(73) Assignee: Madison Company Branford, CT

(21) Appl. No.: 11/585,066

(22) Filed: Oct. 23, 2006

(51) Int. Cl. G01N 27/02

(52) U.S. Cl. 324/439

(57) ABSTRACT

A fluid conductivity test device for testing the conductivity of a fluid in a container. The device includes a fitting that may mate either directly to or indirectly to a tap on, for example, a keg, to allow the fluid in the container to come into contact with the sensor device. The conductivity of the fluid is measured and compared with known conductivities for identification of the fluid. The entire device is relatively small and light-weight for ease of connection to many different containers.

### FIELD OF THE INVENTION

The invention relates to a conductivity sensor for use in measuring the conductivity of a fluid and more specifically the invention relates to a sensor that may be affixed directly inline with a tap for a keg to measure the conductivity of the fluid for identification of the fluid or discrimination between fluids.

### BACKGROUND OF THE INVENTION

Conductivity sensors have been used to measure the conductivity of fluid passing through a pipe for various reasons. For example, systems have been presented that measure fluid conductivity for prolonging the life of a boiler system and/or increasing system efficiency (U.S. Pat. No. 6,930,486.)

Alternatively, another system has incorporated the use of conductivity sensors for measuring the conductivity of a fluid passing through a pipe during a brewing process. U.S. Pat. No. 6,930,486 (“the '486 patent”), discloses that breweries are being increasingly forced to monitor and document the quality of bottled products to an even greater extent and that monitoring has to be safely carried out “on-line” in the production process. The '486 patent, therefore, discloses use of a system where the conductance of a fluid is measured inductively “in-line” and, at the same time, its temperature is measured in the common pipe during the brewing process. However, while the '486 patent provides for increased control over the brewing process, the relatively large, complex system is limited to a production line process and cannot used for relatively quick fluid measurement in numerous different locations.

Traditionally, bottled spirits are identified at the production and bottling process. The container in which the fluid is deposited may be marked so that the contents may be identified by record. For bottled spirits, a commercial label may be applied to the exterior of the bottle. For larger containers, such as a keg, an identification label may also be applied to the exterior of the container. Records may also be kept identifying a particular label record with the type of spirit deposited in the container. However, records may become lost, may not be complete or may simply be inaccurate.

What is desired then is a system and method for identifying a fluid in a bottled container such as, for example, a keg.

It is also desired to provide a reusable device and/or method that may easily be used at multiple differing locations to identify a fluid in a bottled container.

It is still further desired to provide a relatively small, light-weight detachable device that may be directly connected to, for example, a tap for a keg, for quickly and easily identifying the fluid in the container.

### SUMMARY OF THE INVENTION

These and other objectives are achieved in one advantageous embodiment by the provision of a detachable conductivity sensor that may be affixed to or in line with a tap on, for example, a keg. The conductivity sensor is provided as a portable or detachable device that may be used to identify, via a conductivity test, the content of numerous different containers.

The device is designed to be, for example, temporarily affixed to or inline with, the tap to the container such that the conductivity of the fluid may be directly measured. It is contemplated that the conductivity measurement can then be used to identify the particular fluid in the tap line.

As the device is portable in nature, it is provided as a relatively light-weight and compact device. In one embodiment, the device is provided having a case with a circuit board mounted therein and a connector designed to mate with a tap such that the fluid can come into contact with the device. An electrical connection may be provided to the device to provide power to and receive a signal from the device. In addition, a display may be provided to provide the user with an identification of the fluid.

In one advantageous embodiment a device for identifying a fluid in a container is provided comprising a housing defining an interior cavity and having at least one exterior wall and a conductivity sensor positioned within the interior cavity. The device further comprises at least one fitting positioned on the at least one exterior wall. The device is provided such that the at least one fitting is attachable inline with a tap on the container (e.g. directly or indirectly attached to the tap) such that the fluid in the container is passed to the conductivity sensor. The device still further comprises a set of conductivity values corresponding to an identified set of beverages, where each beverage has a distinct conductivity value. The device is provided such that the conductivity sensor measures the conductivity of the fluid to generate an actual conductivity measurement and the fluid is identified based on the actual conductivity measurement and the set of conductivity values.

In another advantageous embodiment a method for identifying a fluid in a container is provided comprising the steps of positioning a conductivity sensor in a housing, positioning at least one fitting on an exterior wall of the housing and attaching the at least one fitting inline with a tap on the container. The method further comprises the steps of passing fluid from the container to the conductivity sensor through the at least one fitting and measuring the conductivity of the fluid. The method still further comprises the steps of comparing the measured conductivity of the fluid to a set of conductivity values and determining the identity of the fluid by matching the measured conductivity to one of the conductivity values in the set of conductivity values.

In still another advantageous embodiment a device for identifying a fluid in a container is provided comprising a housing having a circuit board conductivity sensor positioned therein, the sensor sealed to prevent fluid from affecting the operation of the sensor. The device further comprises a fluid fitting affixed to an exterior of the housing, the fitting attachable inline with a tap on the container such that fluid is passed from the interior of the container to the sensor. The device still further comprises a conductivity measurement of the fluid impinging on the sensor and a set of conductivity values corresponding to an identified set of beverages, each beverage having a different conductivity value. The device is provided such that the fluid is identified based on a comparison of the actual conductivity measurement to the set of conductivity values. The device further comprises a display providing a user with the fluid identification.

Other objects of the invention and its particular features and advantages will become more apparent from consideration of the following drawings and accompanying detailed description.

### BRIEF DESCRIPTION OF THE DRAWINGS

FIG. 1 is block diagram of one advantageous embodiment of the present invention.

FIG. 2 is an illustration of one advantageous embodiment of the fluid conductivity sensor according to FIG. 1.

FIG. 3 is a schematic diagram of one advantageous embodiment of the fluid conductivity sensor according to FIG. 2.

### DETAILED DESCRIPTION OF THE INVENTION

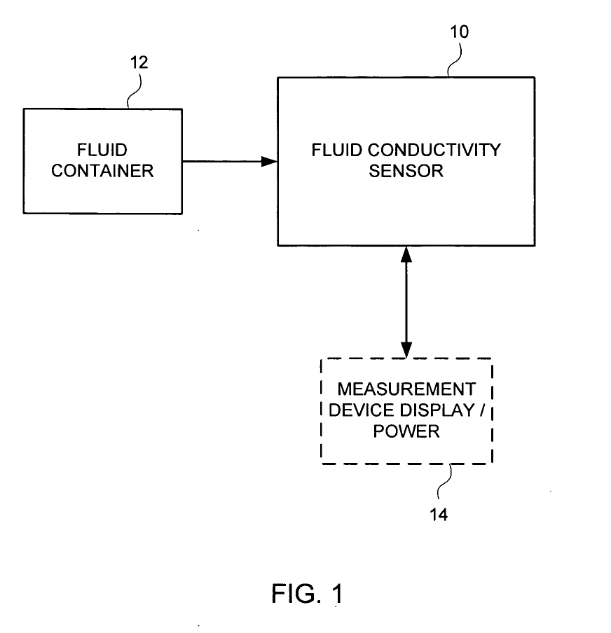

Referring now to FIGS. 1-3, wherein like reference numerals designate corresponding structure throughout the views.

FIG. 1 is a block diagram depicting fluid conductivity sensor 10 coupled to fluid container 12. Fluid conductivity sensor 10 is directly coupled to fluid container 12 so that fluid comes directly into contact with fluid conductivity sensor 10.

The fluid conductivity sensor 10 is provided to measure the conductivity of any type of fluid; however, it is contemplated that the fluid may advantageously comprise spirits, such as for example, beer. In one embodiment, the conductivity sensor may be attached to a beer keg to detect and determine the type of beer connected to the beer tap. The conductivity sensor 10 may be placed directly in the line connecting the beer tap to the keg.

Also illustrated in FIG. 1 is measurement device display/power 14. Measurement device display/power 14 is illustrated as a dashed line to indicate that this is an optional feature. It is contemplated that virtually any type of display may be utilized; however, a relatively small, light-weight display such as, for example, an LCD may advantageously be utilized for local display of the fluid identification.

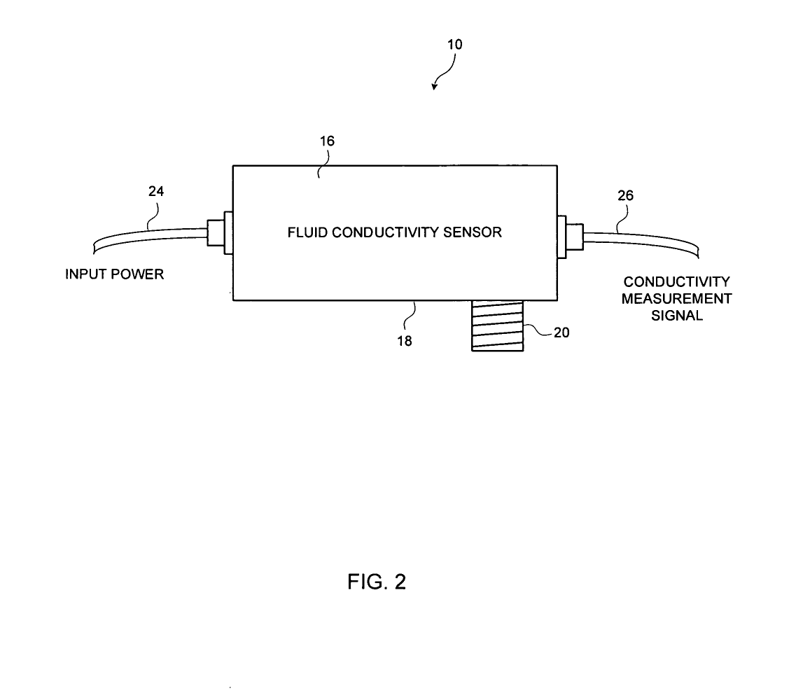

Referring to FIG. 2, one advantageous embodiment of the fluid conductivity sensor 10 is illustrated. In this illustration, fluid conductivity sensor 10 includes a housing 16, which may comprise, for example, a hard plastic such as polypropylene. Attached to an outer wall 18 of housing 16 is a fitting 20, which is designed to be attached inline with (e.g. directly or indirectly) a tap (not shown) of a fluid container 12. Tap 20 may be provided as, for example, a threaded connector designed to engage with, for example but not limited to, a ⅜ inch line or tubing such as is used with a keg.

Also illustrated in FIG. 2 is an input power connection 24, which provides input power for fluid conductivity sensor 10. It should be noted, however, that fluid conductivity sensor 10 may be provided with an internal power source, such as a rechargeable battery, eliminating the need for input power connection 24.

Still further illustrated is conductivity measurement signal connection 26, which provides a signal, related to the fluid conductivity measurement. Again, it should be noted that, while a hard-wired system is illustrated, it is contemplated that a wireless connection, such as for example, a wireless network connection, an infrared coupling or the like, may also be used for wirelessly transmitting information related to the fluid conductivity measurement as desired.

In addition, it is further contemplated that the sensor 10 may be provided with a network connection for transmitting the information related to the fluid conductivity measurement over a network. The network connection may comprise, for example, an internetwork connection, LAN, WAN and/or Internet connection and may be used to transmit the information to a local computer terminal or device or to a remote location.

Accordingly, a relatively light-weight portable device is provided that may easily be moved from one fluid container 12 to another for rapid determination and/or confirmation of the fluid in each container.

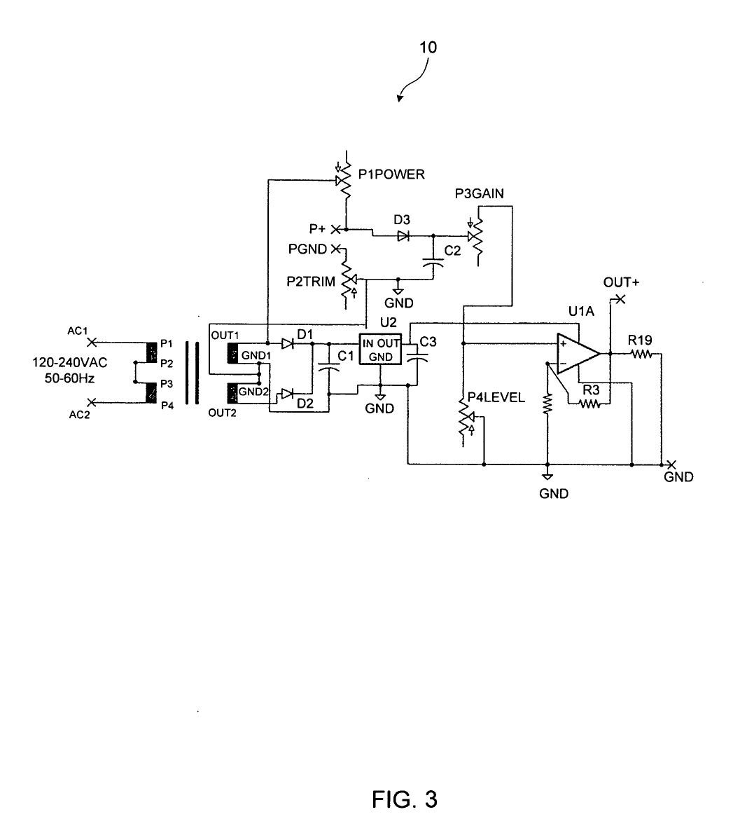

FIG. 3 is a schematic diagram of one advantageous embodiment of fluid conductivity sensor 10. The fluid conductivity sensor 10 is provided to measure the actual fluid conductivity and produce a 0-10 Volt output. The sensor 10 may be provided to output 10 V at the lowest conductivity measurement and 0 V at the highest conductivity measurement, however, the sensor may not actually go completely to zero volts.

It is contemplated that an identified set of conductivity values corresponding to a set of beverages may be obtained, where each beverage has a distinct conductivity value. Accordingly, an actual conductivity measurement may be made in Micro Seimans per CM, which is compared to the identified set of conductivity values. Once the actual measurement is match to an identified value, the fluid may be identified.

A number of potentiometers are illustrated in the schematic diagram including, P1 (power), P2 (trim), P3 (gain) and P4 (level). The four potentiometers are used to adjust the calibration of fluid conductivity sensor 10. Potentiometer P1 is used to set the span of the sensor. It is contemplated that the adjustable conductivity range of the sensor 10 is from approximately 100 to 5,000 Micro Siemans per CM. Potentiometers P2 and P4 are used to offset the DC 10X amplifier. Potentiometer P3 is used to set the zero or closest to zero level of the AC side of the sensor.

In one advantageous embodiment, the fluid conductivity sensor 10 may be set for 10 Volts to substantially equal 1,000 Micro Siemens and 2.9 Volts being 2,500 Micro Siemens.

The components illustrated in the schematic diagram of the fluid conductivity sensor 10 may, in one advantageous embodiment have the following values, identifications and/or part numbers:

TABLE 1

| | |
|---|---|
| Diode D1 | 1N4004 |
| Diode D2 | 1N4004 |
| Diode D3 | 1N4004 |
| Capacitor C1 | 330 μF |
| Capacitor C2 | .1 μF |
| Capacitor C3 | .01 μF |
| R3 | 2.0 MΩ |
| R4 | 220 KΩ |
| R19 | 2.0 KΩ |
| U1A | LM358D |
| U2 | +12 V Regulator |
| P1 (Power) | 100K Ohms |
| P2 (Trim) | 10K Ohms |
| P3 (Gain) | 20K Ohms |
| P4 (Level) | 5M Ohms |

It is further contemplated that conductivity range of the sensor 10 is provided as a circuit board mounted device that is positioned in an interior cavity of housing 16. In this manner, sensor 10 may be rapidly and easily manufactured and/or repaired by insertion and removal of the circuit board.

In addition, the circuit board may advantageously be provided as a sealed device such that the electronics are liquid-tight providing protection to the equipment and to any potential user(s).

While the sensor 10 has been described in one advantageous embodiment (FIG. 3) by the interconnection of a number of discrete electronic components, it is contemplated that the sensor 10 may comprise a programmable microprocessor or a logic array or a combination thereof of software, hardware and/or firmware to achieve the same or similar results. In any event, the sensor 10 will advantageously be attachable directly to the tap line for a direct conductivity measurement of the fluid such that the identity of the fluid can be determined. The sensor 10 provides a variable voltage output corresponding to the measured conductivity, which may be compared to a table of know conductivities for identified beverages, the output voltage corresponding to a particular beverage. It is contemplated that the step of comparing the output voltage with a table of known beverages may be performed either locally within the sensor 10 for local display or may be performed by a processor for either local and/or remote display.

In this manner, a user may quickly and easily determine the identity of a fluid in a container by rapid, simple conductivity test instrument that may be attached directly to the tap.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A device for identifying a fluid in a container comprising:
a housing defining an interior cavity and having at least one exterior wall;
a conductivity sensor positioned within the interior cavity;
at least one fitting positioned on the at least one exterior wall;
said at least one fitting attachable inline with a tap on the container such that the fluid in the container is passed to said conductivity sensor;
a set of conductivity values corresponding to an identified set of beverages, where each beverage has a distinct conductivity value;
said conductivity sensor measuring the conductivity of the fluid to generate an actual conductivity measurement; and
said fluid identified based on the actual conductivity measurement and said set of conductivity values.

2. The device according to claim 1 where said conductivity sensor comprises at least one potentiometer that calibrates the said conductivity sensor.

3. The device according to claim 2 wherein said potentiometer is adjustable to calibrate said conductivity sensor to produce approximately a 0 to 10 volt output.

4. The device according to claim 2 wherein said at least one potentiometer comprises at least two potentiometers, the first potentiometer setting the span of the sensor and the second potentiometer setting the zero or closest to zero level of an AC side of the conductivity sensor.

5. The device according to claim 4 wherein said at least two potentiometers comprises at least four potentiometers, the third and the fourth potentiometers setting the offset of a DC amplifier.

6. The device according to claim 1 wherein said conductivity sensor is circuit board mounted within the interior cavity.

7. The device according to claim 6 wherein the circuit board is sealed to be liquid-tight.

8. The device according to claim 1 wherein the actual conductivity measurement is measured in Micro Siemens per CM.

9. The device according to claim 8 wherein said conductivity sensor has a range that is adjustable from approximately 100 to approximately 5,000 Micro Siemens per CM.

10. The device according to claim 1 further comprising a display for displaying information related to the identification of the fluid.

11. The device according to claim 1 further comprising an electrical connection for providing electrical power to said conductivity sensor.

12. The device according to claim 1 further comprising a data connection for transmitting information relating to the identification of the fluid.

13. The device according to claim 1 wherein said at least one fitting comprises a fitting directly attachable to a ⅜ inch line.

14. The device according to claim 13 wherein said fitting is a threaded fitting.

15. The device according to claim 1 wherein said housing comprises polypropylene.

16. A method for identifying a fluid in a container comprising the steps of:
positioning a conductivity sensor in a housing;
positioning at least one fitting on an exterior wall of the housing;
attaching the at least one fitting inline with a tap on the container;
passing fluid from the container to the conductivity sensor through the at least one fitting;
measuring the conductivity of the fluid;
comparing the measured conductivity of the fluid to a set of conductivity values; and
determining the identity of the fluid by matching the measured conductivity to one of the conductivity values in the set of conductivity values.

17. The method according to claim 16 further comprising the step of adjusting a potentiometer to calibrate the conductivity sensor.

18. The method according to claim 16 further comprising the step of displaying the identity of the fluid to a user.

19. A device for identifying a fluid in a container comprising:
a housing having a circuit board conductivity sensor positioned therein, said sensor sealed to prevent fluid from affecting the operation of the sensor;
a fluid fitting affixed to an exterior of the housing, said fitting attachable inline with a tap on the container such that fluid is passed from the interior of the container to the sensor;
a conductivity measurement of the fluid impinging on the sensor;
a set of conductivity values corresponding to an identified set of beverages, each beverage having a different conductivity value;
said fluid identified and/or differentiated based on a comparison of the actual conductivity measurement to said set of conductivity values; and
a display providing a user with the fluid identification and/or differentiation.
